(19) United States
(12) Patent Application Publication
(10) Pub. No.: US 2009/0008010 A1
(43) Pub. Date: Jan. 8, 2009

(54) ARTICLE AND METHOD FOR IMPROVING VEHICLE MILEAGE THROUGH GRADUAL INCREASE OF TIRE PRESSURE AS A VARIABLE OF INCREASED SPEED

(76) Inventor: Gene Hirs, Waterford, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/774,234

(22) Filed: Jul. 6, 2007

(51) Int. Cl. B29D 30/00; B60C 1/00

(52) U.S. Cl. 152/209.1; 156/110.1

(57) ABSTRACT

The present invention relates to an article and a method of improving vehicle mileage by modifying and increasing the tire tread pressure above the internal tire air pressure resulting in lowering the rolling friction.

### BACKGROUND OF THE INVENTION

1. Field of the Invention

The present invention relates generally to an article and associated method for improving vehicle mileage. More specifically, the invention discloses increasing tread tire pressure while maintaining a same internal air pressure, this resulting in better mileage. By adding a balanced and homogenous weight to the inside surface of the tire treads, centrifugal forces are created which in turn create additional pressure on the tire treads, this resulting in additional mileage per quantity of fuel, by reducing rolling friction.

2. Description of the Prior Art

It is well known that increasing an internal air pressure within a vehicle tire can improve mileage efficiency. High air pressure can reduce riding comfort as a result of vibrations and lessened cushioning effect, this resulting from the increased internal tire pressurization. The recommended tire air pressure, usually dictated by the vehicle manufacture, is intended as a balance to the above referenced considerations and is found to be a compromise between comfort, safety and mileage.

### SUMMARY OF THE PRESENT INVENTION

The present invention relates to an article and a method of improving vehicle mileage by modifying and increasing the tire tread pressure above the internal tire air pressure resulting in lowering the rolling friction.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is cross-sectional illustration of a selected tire, and showing a volume of material, molded to the inside of the tread;

FIG. 2 is a modified version of the illustration of FIG. 1; and

FIG. 3 is a chart illustration of various data associated with a vehicle tire preset to 15 lbs added tread weight.

### DETAILED DESCRIPTION OF THE PREFERRED EMBODIMENTS

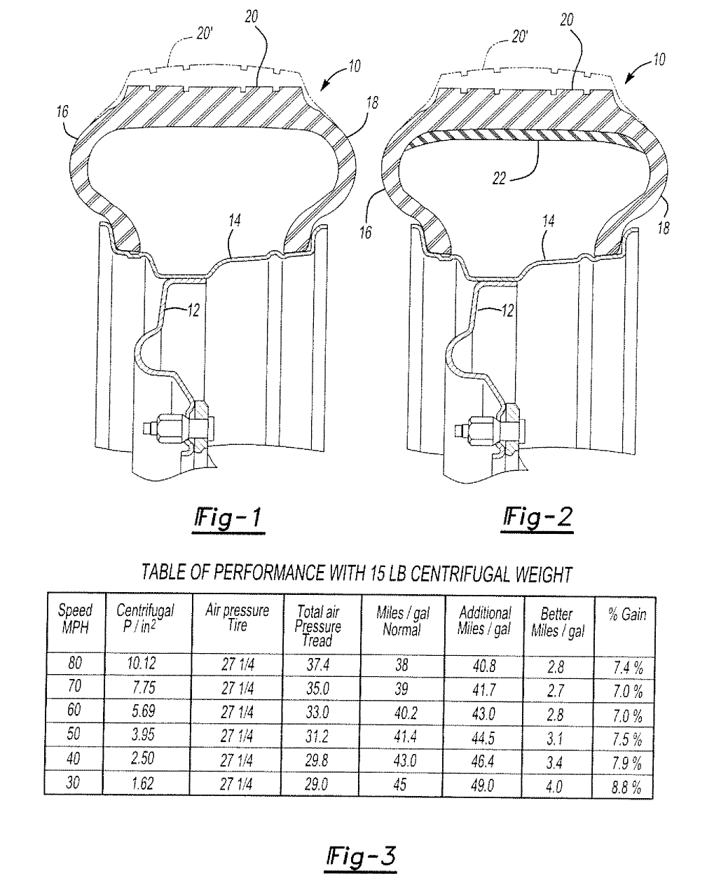

Referring now to FIG. 1, a cross-sectional illustration is illustrated at 10 of a selected tire according to the present invention. The concept of the present invention is the application of a weighted material of some type, in adhering fashion against an inner tread wall of a vehicle, and for the purpose of influencing the tread wall outwardly upon rotation of the tire and in order to achieve a greater pressurization than which is otherwise normally measured within the tire, this increasing the overall fuel efficiency and without otherwise comprising the ride (e.g. vibration) and safety aspects of the vehicle.

As will also be described in subsequent variants, the inserted weighted material is a homogenously/evenly applied material or, alternatively, a centrifugally generated pressure applied against the tire tread interior in order to increase an internal tread pressure of the same. As described previously, the present invention discloses the ability to increase an effective tire tread pressure as a function of its rotational speed, and without the need for over-pressurizing the volume of air or other gas within the tire.

Referring again to the variant of FIG. 1, the tire 10, illustrated in cross-sectional cutaway, includes a wheel 12 defining an annular rim 14. The tire tread (as shown in cutaway) includes side walls 16 and 18 and an annular tread wall 20.

By example tests were conducted on a smaller sized vehicle with measured tire pressures of 27½ psi, for speeds of travel ranging from 30 mph to 80 mph. At this point, and by adding 15 lbs of weight to the tread, an additional calculated psi would be added to the treads. When mileage was established at each speed, from 30 mph to 80 mph, this produced a base reading in which to start for comparisons to the actual addition of the 15 lb weight and reflected by outwardly deflected wall 20′.

FIG. 2 substantially represents the features shown in FIG. 1, with the additional illustration of a fixed and homogenous material 22 along the inner tread wall of the tire, such as in the form of a fixed metallic band, loop or like secured about the inner circumferential wall of the tire tread. A preferred variant of a weight would include a suitable material totaling 12-18 lbs. Another application may include the intermixing a mixture of rubber and powderized metal during initial manufacture of a tire and such that the rubber/metal mixture is uniformly dispersed across the tread wall construction.

A further variant can contemplate a sponge-like material for absorbing and retaining a liquid injection within the tire to assist in creating the necessary centrifugal driven forces during rotation of the tire. FIG. 3 further illustrates a chart of various data associated with a vehicle tire preset to 15 lbs added tread weight.

An associated method for increasing vehicle mileage by reducing rolling friction also includes the steps of applying a pressure against an inner surface of the tire opposite an outer tread above a normal static pressure and resulting from rotation of the tire and concurrently reducing tire contact with a ground surface. Additional steps include intermixing a mixture of rubber and powderized metal during initial manufacture of a tire and such that the rubber/metal mixture is uniformly dispersed across the tread wall construction.

Having described my invention, other and additional preferred embodiments will become apparent to those skilled in the art to which it pertains and without deviating from the scope of the appended claims.

I claim:

1. An assembly for increasing vehicle mileage by adding weight and integrating it with an interior surface of a tire tread such that, during rotation of the tire, additional centrifugal forces increase an externally directed tread pressure beyond a normal static air pressure, thereby reducing rolling friction while maintaining riding comfort at a lower internal air pressure in each of a plurality of tires.

2. The assembly as described in claim 1, said weight further comprising a fixed and homogeneous material secured about said inner tread wall.

3. The assembly as described in claim 1, said weight having a specified shape and size and comprising a material content ranging from 12-18 lbs.

4. A method for increasing vehicle mileage by reducing rolling friction, comprising the steps of:
applying a pressure against an inner surface of the tire opposite an outer tread above a normal static pressure and resulting from rotation of the tire; and
concurrently reducing tire contact with a ground surface.

5. The method as described in claim 4, further comprising the step of intermixing a mixture of rubber and powderized metal during initial manufacture of a tire and such that the rubber/metal mixture is uniformly dispersed across the tread wall construction.
